(19) United States
(12) Patent Application Publication
(10) Pub. No.: US 2004/0014228 A1
(43) Pub. Date: Jan. 22, 2004

(54) Method and apparatus for selectively retrieving biological samples for processing

(75) Inventors: Stafford J. Brignac JR., The Woodlands, TX (US); Michael E. Hogan, Conroe, TX (US); Terri King, Houston, TX (US)

Correspondence Address: Robert D. Touslee, 29 Golden Eagle Lane, Littleton, CO, 80127, US

(73) Assignee: GENOMETRIX GENOMICS INC.

(21) Appl. No.: 10/617,930

(22) Filed: Jul. 11, 2003

Related U.S. Application Data
(63) Continuation of application No. 09/651,977, filed on Aug. 31, 2000.
Application No. 09/651,977 is a continuation of application No. 09/637,285, filed on Aug. 11, 2000, now abandoned.
(60) Provisional application No. 60/161,694, filed on Oct. 26, 1999.

(51) Int. Cl. G01N 35/00

(52) U.S. Cl. 436/43; 422/65; 422/63

(57) ABSTRACT

Biological retrieval system employing a DNA biological specimen repository and robotic mechanism for automated retrieval and processing of the individual specimens. The DNA repository includes individual specimens which include an identification code readable by the robotic assembly and correlated with medical information about the individual whose specimen is on file. The medical information is housed within a database. Upon request, a population sample is determined from the database and the robotic system retrieves particular specimens for subsequent processing. Selected specimens are delivered to a first staging area. At that point, a feeder assembly relocates the biological specimens to a second staging area for punching by a punch head assembly. The punch head assembly moves each pellet or punched sample to a predetermined location, such as for example, a single well of a multiwell tray for subsequent biological processing.

### RELATED APPLICATIONS

This application is based on U.S. provisional application No. 60/161,694, filed Oct. 26, 1999, incorporated herein by reference.

### FIELD OF THE INVENTION

This invention relates to a method and apparatus for selectively retrieving biological samples for processing. More particularly, this invention relates to a DNA biological repository and the selection of specific biological specimens from the repository for subsequent processing.

### BACKGROUND

The related fields of pharmacogenomics and genetic epidemiology have matured rapidly as spin-offs from the human genome project. Single nucleotide polymorphism (SNP) data is accumulating at a rapid pace due to re-sequencing of the human genome. Large-scale SNP discovery initiatives in the U.S. and Japan are defining high variability in the genetic make-up of the human population at the nucleotide level.

Such large-scale genetic projects require the study of gene polymorphism in very large human sample sets, as large as 100,000 to 500,000, in a manner that allows rapid, random access to genetic material from such samples at rates on the order of thousands per day.

As a result of managing such large sample libraries, a bottleneck has developed relative to the long-term storage of DNA samples and rapid, random-access retrieval of DNA from such libraries. It is therefore desirable to provide technology supporting high-throughput genotyping that includes the permanent storage and indexing of such samples and rapid, addressable and substantially automatic processing of the genetic material in such samples.

### SUMMARY OF THE INVENTION

Briefly, the invention is a biological retrieval system having a repository of biological specimens. A robotic mechanism is provided for retrieving predetermined specimens based on an identification code associated with each specimen, the identification of which particular specimen to retrieve is determined from a database. The robotic mechanism delivers the selected specimens to a first staging area. A feeder assembly retrieves such specimens from the first staging area and removes specific specimens for delivery to a second staging area. At the second staging area, a small sample is punched or removed from each specimen thereby providing the biological sample. Each biological sample is then delivered to a third staging area which may be, for example, a multiwell tray assembly. Each biological sample is then deposited in one well of the multiwell tray and is thereby uniquely associated with a particular individual whose medical data is on the database. The samples are then available for subsequent processing, such as purification and amplification, and then for genotyping, genoexpressing, or other biological processing. The robotic mechanism also returns the retrieved specimen from the first staging area back to the repository.

The present invention also includes an apparatus associated with removing a biological sample from the substrate of each biological specimen. This apparatus includes a feeder assembly which retrieves the specimen from the second staging area and delivers each individual specimen to a punching plate, also referred to as the second staging area. A punch head assembly of the apparatus removes a small biological sample from the substrate of each specimen. The punch head includes a tip to punch a pellet from the specimen, a reservoir to retain the pellet while it is transferred from second staging area to the third staging area. A position controller is included to selectively position the reservoir containing the pellet over a particular spot, or well of the multiwell tray, the third staging area. The punch head also includes an injector to remove the pellet and deposit it in the precise well. Alternatively, the retrieval of the pellet may be performed by a laser cutting system rather than a mechanical punch. However, the delivery is the same.

In practicing the method of the present invention, one first identifies, using a database, particular specimens to be retrieved from the DNA biological repository. Such specimens are then retrieved and delivered to the first staging area. The retrieved specimens are then taken from the first staging area and delivered individually or as a predetermined grouping to a second staging wherein, on an individual basis, a biological sample is removed from each specimen. That biological sample is then delivered to a third staging area for subsequent processing. Such subsequent processing may include purification of the sample and then amplification using standard PCR techniques. Preferably, each sample is delivered to a particular location at the third staging area, such as a particular well of the multiwell tray, which uniquely associates the DNA biological sample deposited in each well with a particular individual whose medical history can be found and correlated on the database. Following amplification the DNA samples may be used in genotyping or genoexpressing, for example, as disclosed and claimed in pending U.S. patent application Ser. No. 09/217,154, which application is hereby incorporated by reference.

The details of one or more embodiments of the invention are set forth in the accompanying drawings and the description below. Other features, objects, and advantages of the invention will be apparent from the description and drawings and from the claims.

### DESCRIPTION OF THE DRAWINGS

FIG. 1 is an overall flow chart of the present invention.

FIG. 2 is a plan view of a disassembled slide containing a biological specimen of the present invention.

FIG. 3 is an elevation view of the feeder and punching assemblies of the present invention.

FIG. 4 is a plan view of a portion of the feeder and punching assemblies taken along line 4-4 of FIG. 3.

FIG. 5 is a detailed elevation view of the punching assembly of the present invention.

FIG. 6 is a block diagram of a position controller of the present invention.

FIG. 7 is a block diagram of a punching controller of the present invention.

### DETAILED DESCRIPTION

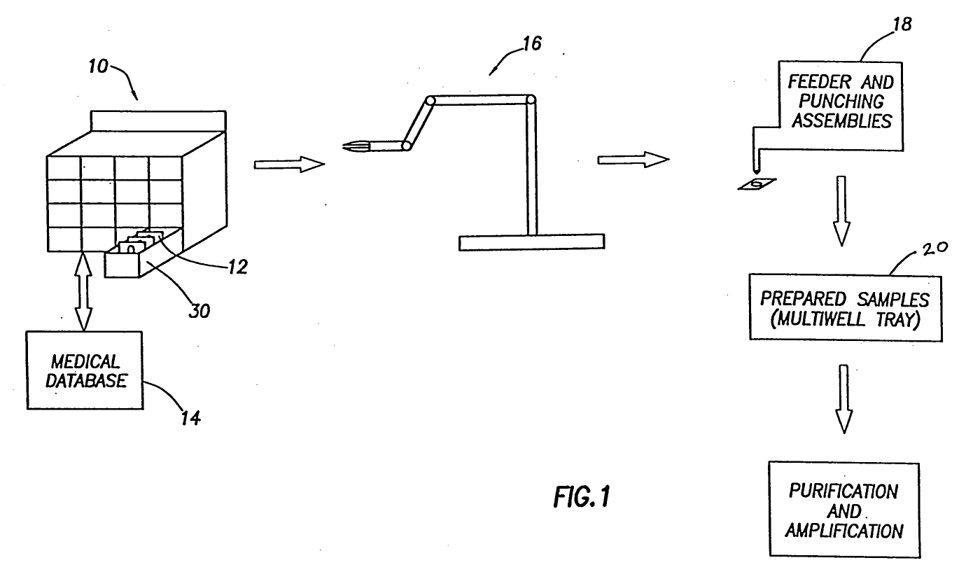

Referring to FIG. 1, an overall flow chart is shown of the present invention. A repository 10 of DNA biological samples 12, preferably blood samples, is shown of individuals and indexed for subsequent retrieval by a robotic system. A database 14 is provided which includes medical information uniquely associated with each DNA sample 12 and includes clinical information about that particular person including recordable phenotypic information, supplemented by follow-on medical history thereby building the individual database for each patient. Upon request, a population base is identified comprising individuals whose DNA samples are found within the repository. These individual samples are retrieved by a robot 16 or other automated means and delivered to feeder and punching assemblies 18 wherein an individual DNA biological sample is punched out of each DNA biological specimen and then robotically delivered, for example, to a multiwell tray 20 for subsequent purification, amplification and biological processing.

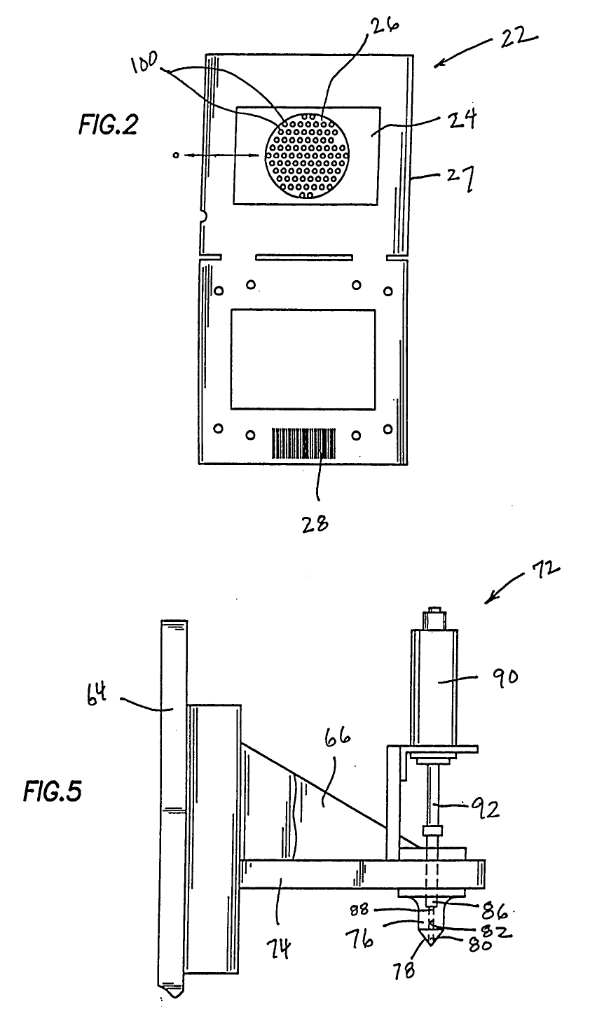

Referring to FIGS. 1-2, the DNA biological repository 10 contains a large number of samples 12, possibly millions. Obviously, the repository may comprise any system capable of indexing particular biological specimens, such as by bar code or other well-known indexing procedures. For purposes of this disclosure, the biological specimens are illustrated as blood samples. However, any specimen may be composed of other biological specimens such as blood serum, blood plasma, blood lymphocytes, fixed or unfixed tissue extracts, buccal scrapes, DNA, RNA or protein. According to the present embodiment, a slide 22 includes a flexible substrate 24 on which a biological specimen 26 has been deposited, in this case one or two drops of blood. The flexible substrate 24 is contained in a relatively rigid frame 27. The frame 27 (unfolded in FIG. 2) may have the dimensions of slide frames typically used for 35 mm photographic slides. The material for the frames may be, for example, cardboard or plastic. The flexible substrate 24 may be a paper material such as FTA paper manufactured by Fitzco. Other suitable papers are manufactured by Life Technologies, Inc. and other well-known supplies. The slide 22 is indexed with indicia 28 printed, stamped, or otherwise placed thereon. The indexing indicia 28 may be, for example, alpha-numeric characters or a bar code for identification by an OCR or bar code scanner, respectively, or other machine readable indicia. Referring still to FIG. 2, the paper substrate 24 accepts a blot of blood or other biological specimen material. Once the biological specimen is deposited on the paper, the cells lyse and component DNA adheres to the paper. Preferably, the DNA sticks to the paper substrate 24 firmly enough so that contaminates may be removed from the paper with hot water or detergent washing without contaminating or diluting the DNA specimen. The paper substrate 24 may be impregnated with agents to inhibit the growth of mold or bacteria during long periods of storage at approximately normal (room) temperature and humidity.

Referring still to FIGS. 1 and 2, each DNA biological specimen housed within frame 27 may be stored in racks or drawers 30 and positioned in such a way as to index their location within a particular tray enabling the correlation of each particular slide within any tray to a corresponding medical record within the database 14. In this manner, and as will be described in more detail below, individual specimens 12 or complete drawers 30 may be retrieved by a robotic system and subsequently processed.

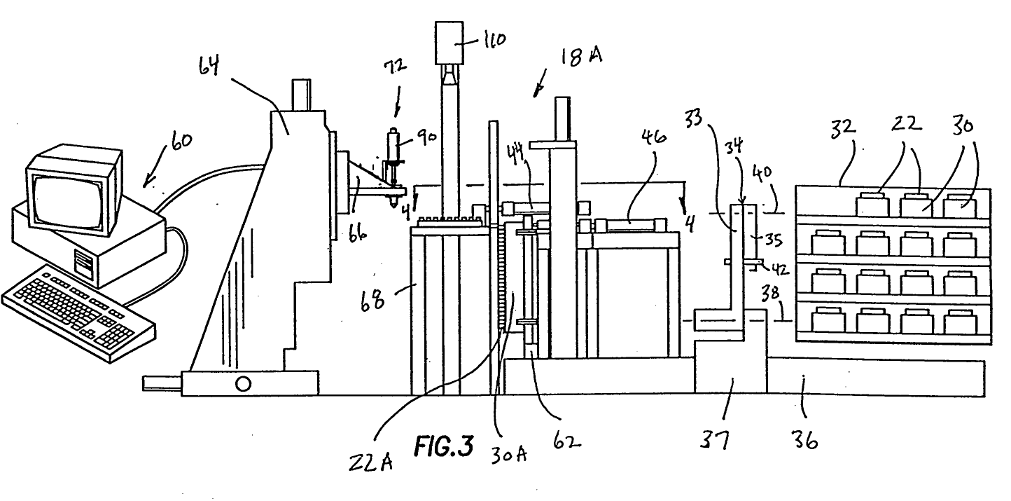

Referring to FIG. 3, feeder and punching assemblies (represented collectively as to element 18 in FIG. 1) are shown. Beginning at the right hand portion of FIG. 3, individual drawers 30 which have been retrieved by robot 16 from the DNA repository 10 are deposited at a first staging area 32. For purposes of illustration only, first staging area 32 is represented by a cabinet having a plurality of drawers 30 each containing multiple specimens 12 or slides 22 positioned therein. A feeder assembly 34 is positioned adjacent to the first staging area 32 and is remotely driven along a track 36, for example, or other positioning means. Feeder assembly 34 includes arms 33 and 35. Arm 33 is pivotally connected at axis 38 to a base 37 and arms 33 and 35 are pivotally connected to each other along axis 40. Assembly 34 includes a hand 42 enabling it to grasp each drawer 30 in first staging area 32. Feeder assembly 34 is adapted to rotate each drawer 30 from a generally horizontal altitude as shown at the first staging area 32 to a vertical altitude as shown by repositioned drawer 30A within the punching assembly 18A. Thus, feeder assembly 34 translates along track 36 and repositions each drawer 30 to a vertical position shown by drawer 30A.

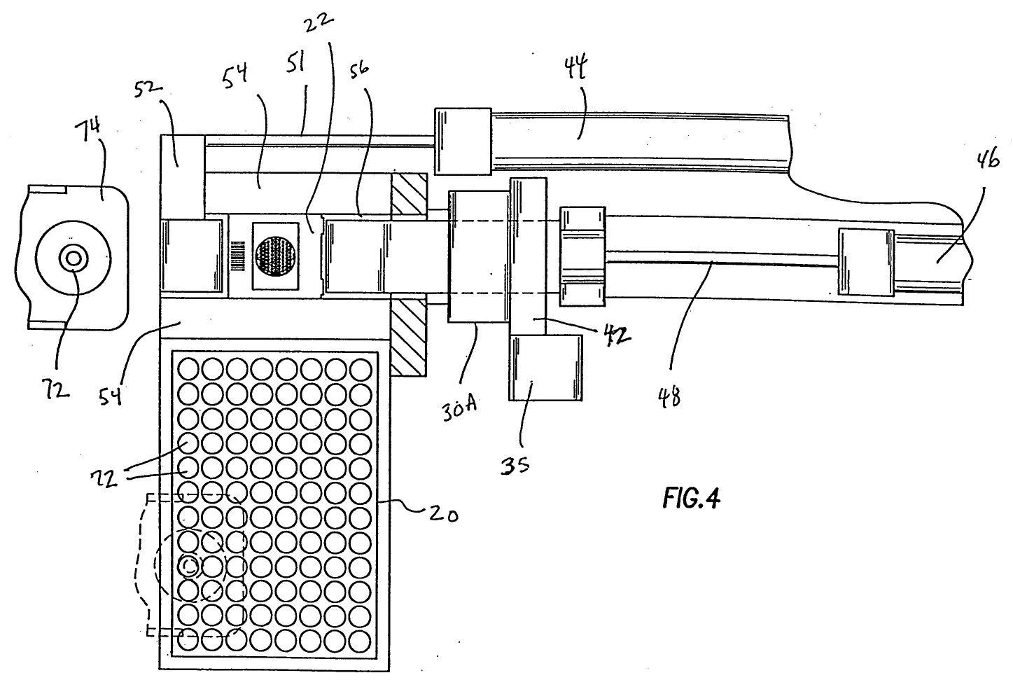

Referring now to FIGS. 3 and 4, the punching assembly includes a series of cylinders 44 and 46. Cylinder 46 includes a rod 48 which is attached to a separating plate 50. Cylinder 44 also includes a rod 51 which is attached to a back up plate 52 and side plates 54. The back of each drawer 30A includes a slotted portion which permits plate 50 to enter through the back portion of each drawer 30A and push a corresponding slide 22 out of drawer 30A and onto a punching plate 56 supported on a frame 68. Once a biological sample has been removed from each specimen as will be described below, cylinder 46 is deactivated and cylinder 44 is activated causing a retraction of rod 51 and thereby causing back up plate 52 to push slide 22 back into its original position within drawer 30A. In this manner, it is possible for the operator using the monitoring and computer system 60 to control the removal of particular slides 22 from a given drawer 30A or, alternatively, possibly every slide in a sequential series from a given drawer 30A which has been positioned vertically within the punching assembly. The present invention includes a motor 62 which moves drawer 30A up and down to position drawer 30A such that sliding plate 50 is positioned slightly above punching plate 56 thereby permitting the horizontal displacement of a given slide 22 by plate 50 from its stored position within drawer 30A onto punching plate 56. This punching position on plate 56 is also referred to from time-to-time as the second staging area. Punching plate 56 may be constructed of a shock absorbing and “self-healing” material. Suitable materials include various hard plastics such as, for example, Delran or polyurethane. As noted above, punching plate 56 and side plate 54 are supported by frame 68 which supports the multiwell tray 20. Tray 20 is shown in FIG. 4 as having 96 individual wells 72. Tray 20 is removable from support frame 68 and is the biological DNA array container for subsequent processing of DNA samples following the punching operation as described herein.

Referring now to FIGS. 3-5, the punching assembly also includes a frame 64 which supports a movable arm 66. The arm 66 is mounted relative to frame 64 and positionable in x, y and z axes relative to punching plate 56. Arm 66 supports a punching mechanism 72. Punching mechanism 72 includes a punch head 76. Punch head 76 includes a tip 78 with a pellet-containing reservoir 80. The reservoir 80 extends into a bore 82. A piston 86 is housed within the bore 82 with one end 88 closely fit to the bore size of the reservoir. The tight fit provides a cleaning action in the reservoir when a pellet is ejected. A solenoid 90 controls rod 92 which in turn depresses the piston 86 through the bore 88 causing the punch head to eject the pellet. This cleaning action substantially removes residual biological material, e.g., paper shreds, in the reservoir remaining from prior punching operations. In this manner, the flexible substrate 24 may be sized to provide a number of pellets. A pellet is the DNA sample removed from the substrate 24. Each pellet 100 (see FIG. 2) may be between about 0.5 and 3.0 mm in diameter. Thus, according to the present embodiment, a slide may be punched up to a number of times. As shown in FIGS. 2 and 4, the sample contains outlines for illustrative purposes only of 96 circular pellets 100. Obviously, each pellet may be differently sized or shaped depending on the shape of the tip 42 of the punch head.

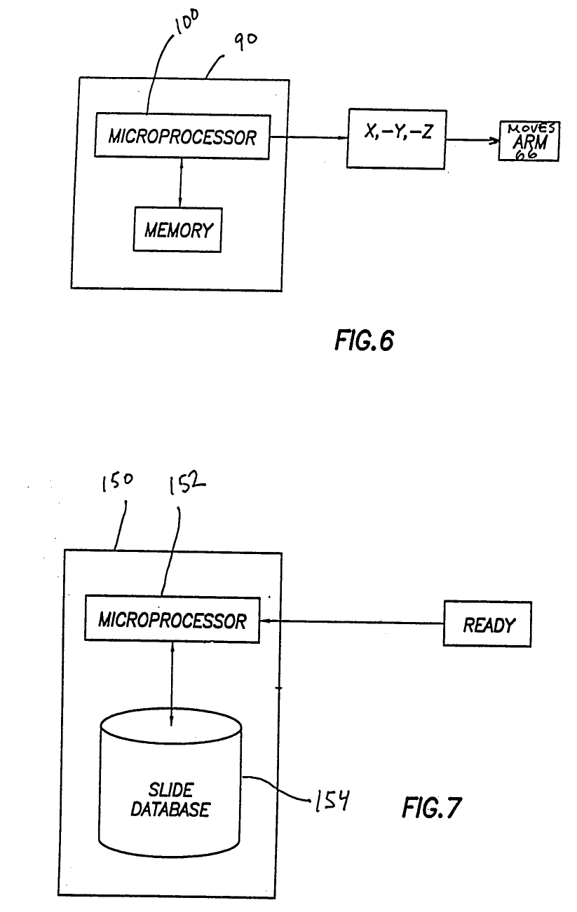

Referring now to FIG. 6, a schematic is shown for the positioning system of the puncher head assembly relative to an x, y, z coordinate. As noted above, arm 66 is positionable relative to frame 64 in x, y and z axes. A position controller 90 is supported within frame 64 to control the movement of punching head 76 in x, y, z coordinates. The controller is operated by a microprocessor 100 and is programmed for particular movement from staging area two to staging area three for each given punch and delivery of a DNA pellet sample. In this manner, position controller 90 is capable of moving punch head 76 over a flexible substrate 24 resting on punching plate 56 and positioning the punch head at a precise location on the biological specimen found on substrate 24. As noted above, each flexible substrate 24 is sized to provide a number of pellets 100 which can be retrieved from a given biological sample.

Referring now to FIG. 7, a schematic is shown for positioning the punch head over a particular spot on a substrate as shown. As noted, the punch head must be precisely located on a given biological specimen to avoid punching the substrate repeatedly in the same place, or alternatively running out of possible pellets from a sample without prior knowledge. To accomplish these objectives, a punching controller 150 is provided which includes a microprocessor 152. Microprocessor 152 is connected to a camera 110 (see FIG. 3), for example a digital camera, that is positioned over each biological specimen on the punching pad 56. Digital camera 110 is capable of detecting previously punched areas and determining viable punching areas remaining on a given substrate 24. Additionally, microprocessor 152 is capable of remembering which particular portions of “real estate” on the blood specimen have already been punched since each specimen is bar coded and microprocessor 152 recalls which locations have been previously punched from a given specimen 12 or substrate 24. To do this, microprocessor 152 is connected to a slide database 154. Each indexed slide 12 has a particular number of “punchable” positions, each having an x and y coordinate stored in database 154. In this manner, prior to punching, microprocessor 152 working with digital camera 110 can inform the operator and microprocessor 100 that a particular slide, identified by its bar code for example, only has space remaining for punching at a particular spot. Thus, the positioning of the punching head on that slide is determined from historical data with each individual blood spot being arranged in a virtual grid.

In the operation of the present invention, an operator or customer performs a search of medical database 14 determining a population sample to study. The identification of particular DNA specimens are then identified and provided to a robotic system 16 which retrieves either individual specimens 12 from the DNA repository 10 or complete drawers or racks 30 containing one or more selected DNA specimens. The robotic system 16 deposits the retrieved specimens in a first staging area 32. A feeder assembly 34 then retrieves the individual drawers 30 which contain either a collection of specimens to be tested or only specimens to-be-selected from each drawer. Each drawer is then rotated by arms 33/35 of feeder assembly 34 from a horizontal attitude to a vertical attitude. Knowing which particular samples are to be punched, the operator initiates drive motor 62 which vertically displaces drawer 30A to a predetermined location. Activation of cylinder 44 advances plate 50 and, in turn, a given specimen 12 from the vertically oriented drawer 30A onto punching plate 56. The operator has pre-programmed microprocessors 110/152 informing each of the particular specimen to be tested. Since microprocessor 152/database 154 know the location of remaining “real estate” on a given specimen, it directs punch head 76 to a precise location on the specimen. Rapid movement in a “z” or vertical direction at the direction of microprocessor 100 causes punch head 76 to pierce substrate 24 dislodging a pellet 100 from the substrate into reservoir 80 of head 76. This is possible because arm 66 is mounted on frame 64 enabling rapid vertical descent (i.e., in the z-axis). Microprocessor 100 then instructs the movement of arm 66 along x, y and z axes to a particular location above a particular well 72 of tray 20. Solenoid 90 is then activated which disposes that particular pellet from reservoir 80 into a particular well 72 and also cleans bore 88 of the head 76 as it ejects the pellet. After a pellet 100 is removed from a particular substrate 24, cylinder 44 is activated returning that particular specimen 22 to its previous location in tray 30A. In this manner, moving a particular specimen 22 from punching plate 56 and the delivery of another specimen 22 to punching plate 56 can occur while punching head 76 is positioning a particular pellet 100 into a specific well of tray 20.

Alternatively, a laser embodiment may be used rather than a mechanical punching assembly. Such laser techniques are well known to those skilled in the art and essentially involve the use of CO₂ lasers to cut a pellet from a substrate in a donut configuration and deposit that pellet in a particular well of a tray 20 using a vacuum to draw the pellet within the tip of a laser and then ejecting the pellet into a particular well by removing the vacuum. Preferably, such lasers are CO₂ vacuum lasers such as those manufactured by Synrad, Inc. of Mukilteo, Wash.

Once the required number of DNA specimens have been removed to fill, or partially fill, a tray 20 as required by a particular operation, tray 20 may be removed and then processed using conventional purification and amplification techniques, such as PCR, for subsequent biological testing or assay. Such assays may include genotyping and gene expression assay. In this manner, the present invention may be used to sample thousands of particular DNA specimens on a daily basis significantly increasing the volume of throughput capacity for subsequent DNA biological processing.

After a sample has been removed by the punch head, the feeder assembly 34 returns the specimen 22 to drawer 30A as described above and the feeder assembly then returns each drawer 30A to the first staging area 32. Robot 16 then returns each individual drawer 30 to the repository 10. Thus, the present invention provides for a plurality of biological specimens 22 stored within the repository 10 in such a manner that they can be selectively retrieved and returned for multiple use due to the plurality of sample space available on each biological specimen. The selective retrieval and returning of such specimens and their reusable nature is a significant benefit of the present invention, particularly when combined with the other attributes of the feeder assembly and the punch head assembly to accomplish the stated objections of the present invention.

As noted above, the foregoing has been described in terms of a blood sample being deposited on a substrate. Obviously, any number of other biological specimens may be used other than blood such as blood serum, blood plasma, blood lymphocytes, fixed or unfixed tissue extracts, buccal scrapes, DNA, RNA or protein.

A preferred embodiment of the invention has been described. Nevertheless, it will be understood that various modifications may be made without departing from the spirit and scope of the invention as disclosed and claimed.

1. A biological retrieval and processing system comprising:
a repository of biological specimens;
a robot for retrieving predetermined specimens from said repository and delivering said retrieved specimens to a first staging area and for returning each specimen from said first staging area back to said repository;
a feeder adapted to retrieve said specimens from said first staging area and deliver each retrieved specimen to a second staging area; and
a punch head operatively associated with said feeder adapted to remove a sample from a substrate of each retrieval specimen and deliver each said sample to a predetermined position at the third staging area.

2. The system of claim 1 wherein said feeder is adapted to return each punched specimen to said first staging area.

3. The system of claim 2 wherein each biological specimen of said repository is capable of providing a plurality of samples.

4. The system of claim 2 wherein said robot includes a reader capable of identifying which specimens to retrieve from said repository.

5. The system of claim 4 wherein said reader is a bar code reader.

6. The system of claim 1 wherein the biological specimen is blood.

7. The system of claim 1 wherein the biological specimen is blood serum.

8. The system of claim 1 wherein the biological specimen is blood plasma.

9. The system of claim 1 wherein the biological specimen is blood lymphocytes.

10. The system of claim 1 wherein the biological specimen is fixed tissue extracts.

11. The system of claim 1 wherein the biological specimen is unfixed tissue extracts.

12. The system of claim 1 wherein the biological specimen is buccal scrapes.

13. The system of claim 3 wherein the biological specimen is purified DNA.

14. The system of claim 3 wherein the biological specimen is purified RNA.

15. The system of claim 3 wherein the biological specimen is purified protein.

16. A biological retrieval and processing system comprising:
a repository of biological specimens;
a robot for retrieving predetermined specimens from said repository and delivering said specimens to a first staging area, and for returning said specimens from said first staging area back to the repository;
a feeder adapted to select said specimens from said first staging area and selectively remove specific specimens for delivery to a second staging area; and
a punch head operatively associated with said feeder adapted to remove a sample from a substrate of each said selectively removed specimens and deliver each said sample to a predetermined position at a third staging area.

17. The system of claim 16 wherein said feeder is adapted to return each punched specimen to said first staging area

18. The system of claim 17 wherein each biological specimen is capable of providing a plurality of samples.

19. A biological retrieval and processing system comprising:
a medical database;
a repository of biological specimens, each specimen having an identification code and correlated to a medical entry in said medical database;
a robot having a reader capable of reading said identification codes and retrieving predetermined specimens from said repository and delivering said retrieved specimens to a first staging area and for returning said specimens back to said repository;
a feeder adapted to retrieve said specimens from said first staging area and deliver each retrieved specimen to a second staging area; and
a punch head operatively associated with said feeder adapted to remove a sample from a substrate of each retrieved specimen and deliver each said sample to a predetermined position in the third staging area,
wherein said feeder returns each punched specimen to said first staging area.

20. A method for collecting selected samples from a repository of biological specimens, comprising the steps of:
identifying specimens for retrieval from the repository;
retrieving the identified specimens from the repository;
delivering the specimens retrieved from the repository to a first staging area;
removing selected specimens retrieved from the first staging area and delivering each said selected specimen to a second staging area;
removing a biological sample from each specimen at the second staging area; and
delivering each biological sample removed from a selected specimen at the second staging area to a third staging area for subsequent processing;

21. The method according to claim 20 wherein the retrieving step is done robotically.

22. The method according to claim 21 wherein the third staging area comprises a multiwell tray providing for the positioning of each sample taken from each specimen into an individual well of said tray and correlatable to the medical records of a particular individual.

23. The method according to claim 20 wherein the method further comprises purifying the individual samples retrieved from each specimen collected in the third staging area for further testing.

24. The method of claim 20 wherein the method also includes identifying which specimens to retrieve from a medical database.

25. The method according to claim 20 wherein the method further comprises purifying and amplifying the individual samples retrieved from each specimen collected in the third strategy area for further testing.

26. An apparatus for preparing biological samples from selected specimens comprising:
a feeder assembly adapted to remove a selected substrate from a storage container;
a punching assembly having a frame and a movable arm supported by said frame and displaceable in an x, y and z axis relative to said frame;
a punch head mounted on the movable arm having
a tip adapted to punch a pellet from the substrate,
a reservoir adapted to retain the pellet, said reservoir adjacent the tip, and
an ejector adapted to eject the pellet from the reservoir; and
a position controller adapted to move the arm and position the tip over the substrate in a first position and position the tip over a sample container in a second position,
said ejector adapted to eject said pellet in said second position.

27. The apparatus of claim 26, wherein the punch head also includes a piston having a first end proximate the reservoir and a second end distal the reservoir, and the apparatus further comprises:
a rod contacted the second end of the piston; and
a solenoid connected to the rod and adapted to actuate the rod.

28. The apparatus of claim 26, wherein the substrate comprises a flexible substrate held in a frame.

29. The apparatus of claim 28, wherein the flexible substrate comprises FTA paper.

30. The apparatus of claim 28, wherein the frame comprises a 35 mm slide frame.

31. The apparatus of claim 26, wherein the storage container comprises a plurality of slots, each adapted to hold a substrate.

32. The apparatus of claim 26 wherein the feeder assembly is further adapted to return the substrate to an original position in the storage container after the substrate is punched.

33. The apparatus of claim 26, wherein the sample container comprises a well in a multiwell tray.

34. The apparatus of claim 26, wherein the substrate comprises indexing indicia, said apparatus further comprising a reader adapted to recognize the indexing indicia.

35. The apparatus of claim 34, wherein the indexing indicia comprises a bar code, and wherein the reader comprises a bar code reader.

36. The apparatus of claim 26 further comprising a slide positioning controller adapted to recognize previously punched areas on the substrate, wherein the position controller is connected to the slide positioning controller and adapted to position the tip over an unpunched area on the substrate in the first position.

37. The apparatus of claim 36, wherein the slide positioning controller includes a microprocessor and an imaging device correlated to said microprocessor.

38. The apparatus of claim 36 further comprising a database comprising data representative of punched or unpunched areas on a substrate corresponding to a particular indexing indicia, wherein the microprocessor is connected to the database and is adapted to position the tip over an unpunched region on the substrate in the first position.

39. An apparatus for preparing biological samples comprising:
a punching pad;
a feeder for delivery of a specimen, having a substrate, to the punching pad;
a punch head having:
a tip adapted to punch a pellet from the substrate,
a reservoir adapted to retain the pellet, said reservoir adjacent the tip, and
means for ejecting the pellet from the reservoir; and
a positioning controller to locate the tip over the substrate in a first position and over a sample container in a second position,
said ejecting means ejecting said pellet in said second position.

40. The apparatus of claim 39 wherein said feeder is adapted to return the specimen to an original position after the substrate is punched.

41. The apparatus of claim 39, wherein the substrate comprises a flexible substrate held in a frame.

42. The apparatus of claim 39, wherein the specimen comprises indexing indicia, and further comprising means for recognizing said indexing indicia.

43. The apparatus of claim 42 further comprising a second positioning controller for identifying a viable punching area on the substrate.

44. A method for retrieving biological samples for processing comprising the steps of:
robotically removing a first DNA specimen from a specimen holder;
automatically positioning the first specimen over a punching pad;
punching a pellet from the first specimen with the tip of a punch head and retaining the pellet in a reservoir in the punch head;
moving the tip over a sample holder; and
depositing the tip in the sample holder.

45. The method of claim 44 further comprising:
loading the first specimen in the specimen holder after the specimen is punched;
removing a second specimen from the specimen holder;
positioning the second specimen on the punching pad; and
moving the tip over the second specimen.

46. The method of claim 44, wherein the specimen includes a flexible substrate held in a frame.

47. The method of claim 44, wherein the specimen includes indexing indicia.

48. The method of claim 44 wherein after the positioning step, the method also includes:
identifying a viable punching area on the specimen by means of a microprocessor; and
automatically positioning the tip over the viable punching area.
